(19) United States
(12) Patent Application Publication
(10) Pub. No.: US 2016/0072588 A1
(43) Pub. Date: Mar. 10, 2016

(54) Method And Apparatus For Processing A Communication Signal In An Optical Communication Network

(71) Applicants: Vincent E. Houtsma, New Providence, NJ (US); Doutje T. Van Veen, New Providence, NJ (US); Alan H. Gnauck, Middletown, NJ (US); Patrick Iannone, Rumson, NJ (US)

(72) Inventors: Vincent E. Houtsma, New Providence, NJ (US); Doutje T. Van Veen, New Providence, NJ (US); Alan H. Gnauck, Middletown, NJ (US); Patrick Iannone, Rumson, NJ (US)

(73) Assignee: ALCATEL-LUCENT USA INC., Murray Hill, NJ (US)

(21) Appl. No.: 14/844,942

(22) Filed: Sep. 3, 2015

Related U.S. Application Data
(60) Provisional application No. 62/047,374, filed on Sep. 8, 2014.

(51) Int. Cl. H04B 10/564; H04B 10/27; H04L 25/08; H04Q 11/00

(52) U.S. Cl. CPC H04B 10/564; H04Q 11/0067; H04B 10/27; H04L 25/085

(57) ABSTRACT

A method and apparatus for processing a communication signal in an optical network. A network node typically includes a transmit train for generating transmissions and a receive train for receiving transmissions from another network node. The network node may be, for example, an OLT or an ONU. In a receiver implementing the described solution, a photodiode is employed to convert received optical signals into electrical signals that are then provided to a TIA or other device for producing a differential output having an inverted output and a non-inverted output. One of the outputs is delayed one bit and attenuated, then combined with the other output to produce an equalized signal for further processing by the receive train. The solution may be analogously applied on the transmit side for introducing pre-distortion, either in addition to or in lieu of in the receiver.

### CROSS-REFERENCE TO RELATED APPLICATIONS

The present disclosure is related to and claims priority from U.S. Provisional Patent Application Ser. No. 62/047,374, entitled Receiver For Communication Network, and filed on 8 Sep. 2014, the entire contents of which are incorporated by reference herein.

### TECHNICAL FIELD

The present invention relates generally to the field of communication networks, and, more particularly, to a method and apparatus for processing a communication signal to alleviate distortion in an optical network.

### BACKGROUND

The following abbreviations are herewith expanded, at least some of which are referred to within the following description of the state-of-the-art and the present invention.
APD Avalanche Photo-Diode
EDC Electronic Dispersion Compensation
FFE Feed-Forward Equalizer
IEEE Institute of Electrical and Electronics Engineers
GPON Gigabit PON
ITU International Telecommunication Union
NGPON Next-Generation PON
OLT Optical Line Terminal
ONT Optical Network Unit
ONU Optical Network Unit
PON Passive Optical Network
RF Radio Frequency
ROSA Receive Optical Subassembly
TIA Trans-Impedance Amplifier
TOSA Transmit Optical Subassembly
XG-PON 10 Gigabit PON

Optical networks send and receive communication signals between various network nodes using optical, or modulated light-wave transmission. Exemplary implementations include optical access networks such as PONs (passive optical networks) that may carry data and other traffic from a main or core network to the premises of many network subscribers. This data may be used to provide television and streaming video, telephone service, and Internet access, among other services.

In the process of optical transmission, distortion can be introduced into the transmitted communication signal, which of course network operators would like to ameliorate or eliminate altogether. This may be done, for example, when a received optical signal is converted into an electrical signal in preparation for further transmission to subscriber equipment or other network nodes. Similarly, known or expected distortion can be countered by pre-distorting a signal.

Note that the techniques or schemes described herein as existing or possible are presented as background for the present invention, but no admission is made thereby that these techniques and schemes were heretofore commercialized or known to others besides the inventors.

### SUMMARY

The present disclosure is directed to a manner of processing a communication signal in an optical network in a manner that is expected to at least mitigate some of the distortion inherent in optical transmissions at high data rates, and do so efficiently and cost-effectively. Although this is the expectation, however, no level of improvement or efficiency is required unless explicitly recited in a particular embodiment.

In one aspect, a method for processing a communication signal in a communication network including producing a differential output of the signal including in inverted output and a non-inverted output, delaying one of the differential outputs, attenuating one of the differential outputs, and combining the delayed differential output with the non-delayed differential output. The delaying and the attenuating may be done on the same differential output, for example, the inverted differential output. The delayed output may be delayed, for example, by one bit.

In some embodiments, the method also includes receiving an optical signal and converting it into an electrical signal, for example an RF signal, for example using a photodiode such as a APD (avalanche photodiode). In other embodiments, the method may include providing the combined signal to a transmission module and converting it into an optical signal.

In another aspect, the present invention provides a apparatus for processing a communication signal including a device configured to produce a differential output such as a TIA (trans-impedance amplifier), delay circuitry for delaying one output of the differential-output device, for example a delay buffer. The delayed output is preferably delayed by one bit. The method also includes attenuating one output of the differential-output device, preferably the same one that was delayed, for example the inverted output. The apparatus according to this aspect also includes a combiner for combining the delayed output and the non-delayed output.

In some embodiments, the apparatus also includes a photodiode, for example and APD, for converting a received optical signal into an electrical signal and providing the electrical signal to the differential-output device. In other embodiments, the apparatus also includes a transmit module for converting the combined output into an optical signal for transmission.

Additional aspects of the invention will be set forth, in part, in the detailed description, figures and any claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE DRAWINGS

A more complete understanding of the present invention may be obtained by reference to the following detailed description when taken in conjunction with the accompanying drawings wherein:

FIG. 1 is a schematic diagram illustrating selected components of an exemplary PON in which embodiments of the present invention may be advantageously implemented;

FIG. 2 is a flow diagram illustrating a method of processing a communication signal in an optical network according to one embodiment;

FIG. 3 is a simplified block diagram illustrating an apparatus for processing a communication signal according to one embodiment;

FIG. 4 is a simplified block diagram illustrating selected components of an exemplary ONU according to another embodiment; and

FIG. 5 is a flow diagram illustrating a method of processing a communication signal in an optical network node according to another embodiment.

### DETAILED DESCRIPTION

Various exemplary embodiments will now be described, and in general they are directed to an advantageous manner of processing a communication signal in a communication network.

This solution may be advantageously applied, for example, in an optical access network such as a PON (passive optical network). Note that the term “PON” is herein intended to be inclusive of all such networks, including for example GPON (gigabit PON), XG-PON (10 gigabit PON), and NGPON2 (next generation PON). Note, however, that the solutions presented herein may also be employed in other types of optical networks. An exemplary PON will now be described and used as an illustration of the methods and apparatus of the proposed solutions.

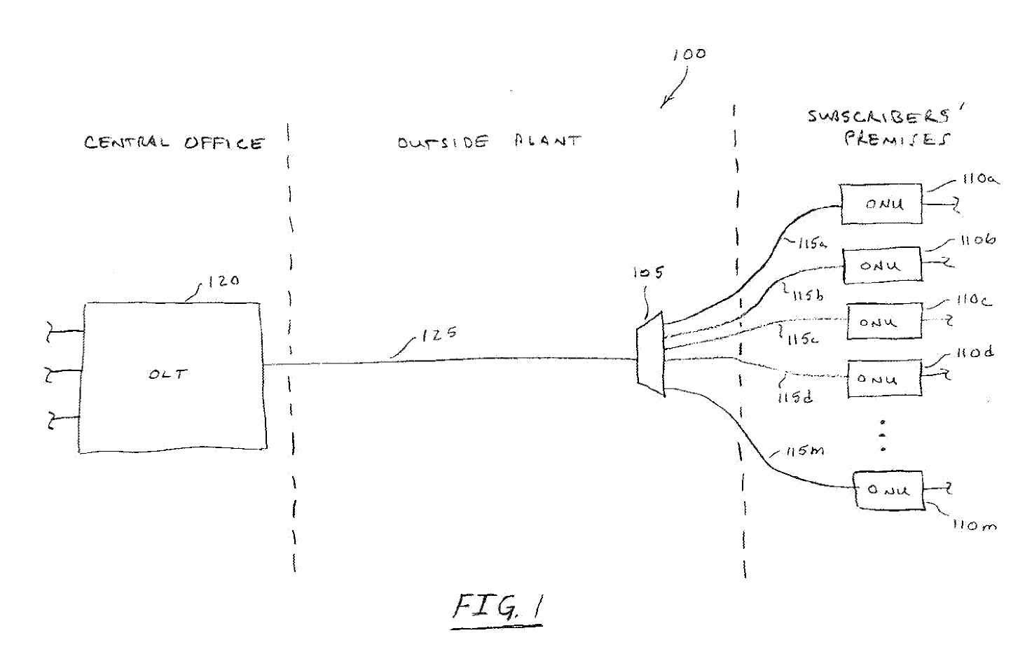

FIG. 1 is a simplified schematic diagram illustrating selecting selected components of a typical PON 100 in which embodiments of the present invention may be implemented. Note that PON 100 may, and in many implementations will, include additional components, and the configuration shown in FIG. 1 is intended to be exemplary rather than limiting. Five ONUs (optical network units), 110a through 110m, are shown, although in a typical PON there may be many more or, in some cases, fewer. In this illustration, each of the ONUs are presumed to be located at and serving a different subscriber, perhaps at their respective residences or other premises. The ONU at each location is connected or connectable to a device of the subscriber, or to a network of such devices (not shown). In some other cases (not shown) an ONU may be associated with multiple subscribers and ultimately service a number of subscriber devices. As used herein, the term “ONU” is considered to include ONTs (optical network terminals) and similar devices, some of which may not necessarily be located at a subscriber's premises.

PON 100 also includes an OLT (optical network terminal) 120, which communicates directly or indirectly with various sources of content and network-accessible services (not shown) that are or may be made available to the subscribers associated with PON 100. As should be apparent, OLT 120 handles the communications between these other entities and the ONUs. OLT 120 may also be involved in regulating the PON and individual ONUs. As mentioned above, the OLT 120 is typically though not necessarily located at a service provider location referred to as a central office. The central office may house multiple OLTs (not separately shown), each managing their own respective PON.

OLT 120 is in at least optical communication with each of the ONUs in the PON 100. In the embodiment of FIG. 1, OLT is connected with the ONUs 110a through 110n via a (feeder) fiber optic cable 125 and (access) fiber optic cables 115a through 115m. In this PON, a single splitter 105 is used to distribute a downstream transmission so that each ONU receives the same downstream signal. In this case, each ONU extracts and uses only its own portion of the downstream transmission. In other optical networks, the splitter may also separate the signal into different wavelengths, if used, associated with each or various of the respective ONUs.

The splitter in a PON is typically a passive element requiring no power. The splitter may be located, for example, in a street-side cabinet near the subscribers it serves (FIG. 1 is not necessarily to scale). This cabinet or similar structure may be referred to as the outside plant. Note, however, that no particular network configuration is a requirement of the present invention unless explicitly stated or apparent from the context.

In the example of FIG. 1, the splitter may also serve as a combiner for combining upstream traffic from the ONUs 110a through 110m to the OLT 120. Upstream transmissions are generally at a different wavelength (or wavelengths) than those of downstream transmissions to avoid interference. In addition, each ONU may be assigned a separate time slot, that is, a schedule for making upstream transmissions.

As in other areas of modern communication, market forces are demanding increased data rates in optical networks. As might be expected, these higher data rates may pose a challenge for the node receiving them. Distortions in the communicated signal may, for example, be introduced by chromatic dispersion in the fiber.

This distortion can be at least partially compensated for by using analog to digital conversion and signal processing. This method, however, is relatively expensive. Moreover, with increasing data rate, some of the available optical components might become bandwidth limiting, further increasing the penalty while detecting the signal. Analog EDC (electronic dispersion compensation) may be used, but may not be available however for the higher data rates expected in next generation system.

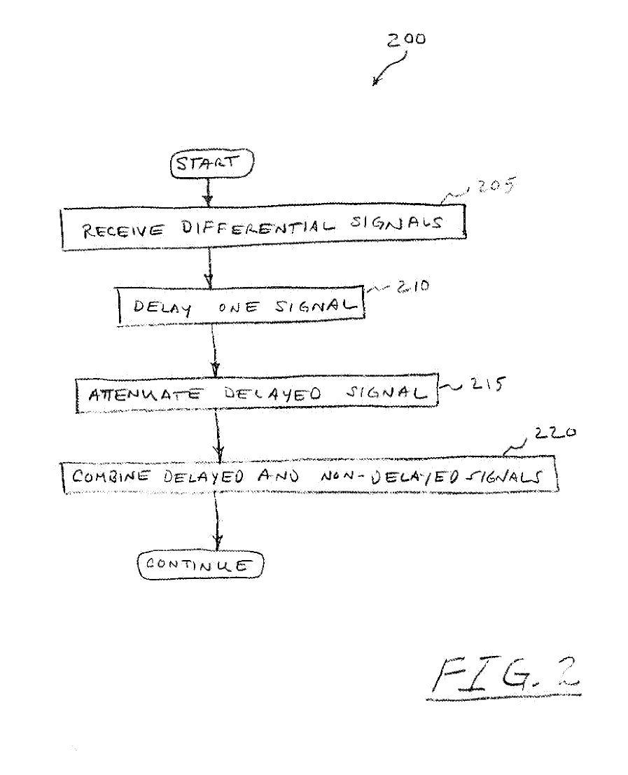

Embodiments presented herein address this and other problems problem by providing for a simply, low-cost equalization solution. One such solution will now be described in reference to FIG. 2.

FIG. 2 is a flow diagram illustrating a method 200 of processing a communication signal in an optical network. Note that the term communication signal simply reflects that in such a network, signals transmitting data and control signals are often converted from optical to electrical signals or vice versa. In this embodiment, the communication signal being processed is generally an RF electrical signal. At START, it is presumed that the components necessary for performing the method are present and configured to perform at least the method of this embodiment.

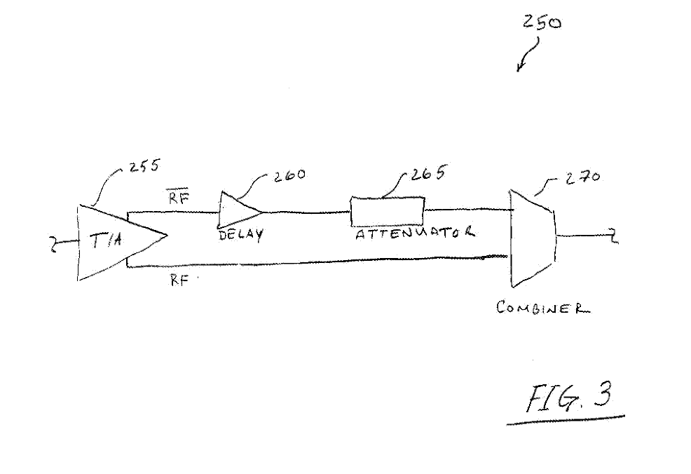

In the embodiment of FIG. 2, the process begins when a communication signal is received (step 205) as differential electrical signals, that is, with one of the signals being an inverted form of the other. The differential signals include the communication signal and an inverted form of the communication signal. Such a differential arrangement may be produced, for example, by a TIA (trans-impedance amplifier) such as the TIA shown in FIG. 3.

In the embodiment of FIG. 2, the inverted signal is then delayed, preferably by one bit (step 210), and attenuated (step 215). The delayed signal is this embodiment than combined (step 220) with the non-inverted signal to form a single, equalized output.

This solution may also be described in terms of an apparatus. FIG. 3 is a simplified block diagram illustrating an apparatus 250 for processing a communication signal, for example according the process illustrated in FIG. 2. In the embodiment of FIG. 3, a TIA 255 outputs a differential communication signal, that is, a signal and the inverse of the signal.

In this embodiment, the inverse output passes through delay circuitry 210 where it is delayed, for example by one bit, with respect to the non-inverse output. An attenuator 215 then attenuates the delayed output and provides the delayed signal to combiner 220, where it is combined with the non-inverted output of TIA 205. In this manner, a single, equalized output is provided for further processing.

The method and apparatus described may be employed in either one or both of and OLT and ONU in a PON such as the PON 100 illustrated in FIG. 1. Exemplary embodiments will now be described in more detail.

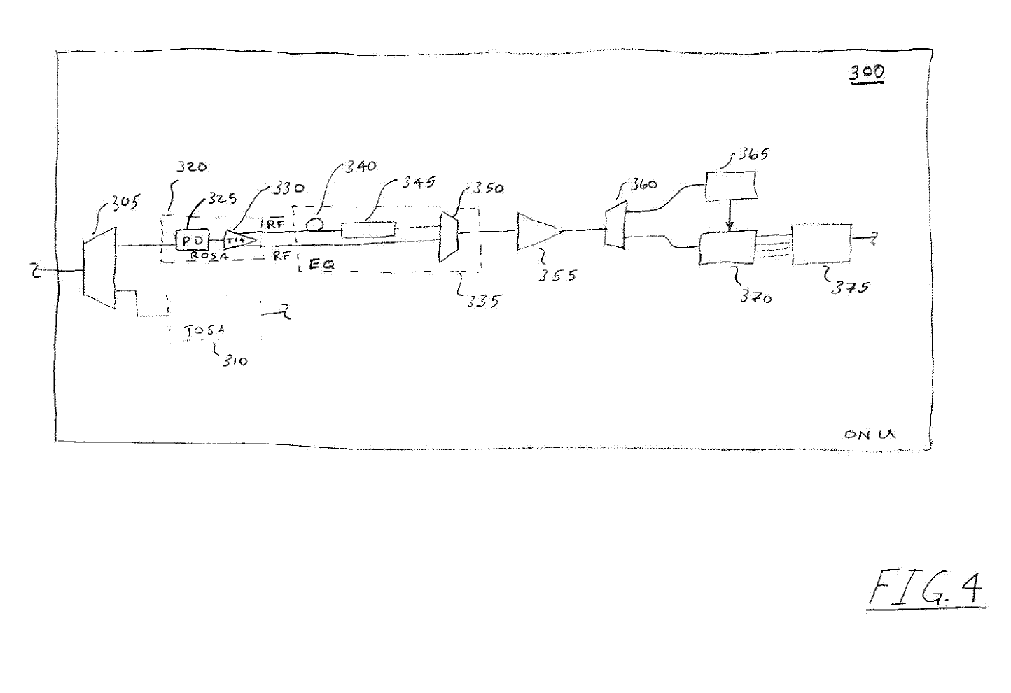

FIG. 4 is a simplified block diagram illustrating selected components of an exemplary ONU 300 according to an embodiment of the present invention. In FIG. 4, most but not all of the components depicted are elements of the ONU 300 receive train. In this embodiment, ONU 300 includes a TOSA (transmit optical subassembly) 310 for converting upstream transmission into optical signals and a ROSA (receive optical subassembly) 320 for converting received optical signals into electrical signals for processing. TOSA 310 and ROSA 320 respectively transmit and receive optical transmissions via splitter/combiner 305, which in turn is in communication with the feeder fiber of a PON, for example feeder fiber 125 illustrated in FIG. 1.

In the embodiment of FIG. 2, ROSA includes a photodiode (PD) 325 and a TIA 330. In operation, the photodiode 325 converts received optical signals into electrical signals, which are provided to TIA 330. Photodiode 325 may be, for example, an APD (avalanche photodiode). TIA 330 has a differential output, typically RF signals, which are represented as RF and RF-bar. Note that in alternate embodiments (not shown), the differential signal may be produced by other components.

In the embodiment of FIG. 4, both of these outputs are provided to equalizer (EQ) 335 processing. Equalizer 335 is preferably an all-analog two-tap FFE (feed forward equalizer), as illustrated in FIG. 4, and includes delay circuitry 340 and attenuation circuitry 345. Delay circuitry 340 (such as a delay buffer) and attenuation circuitry operate in this embodiment to delay the RF-bar signal by one bit and attenuate it before providing the signal to combiner 350. Combiner 350 combines this input with the un-delayed and un-attenuated RF signal from TIA 330 to form an equalized output.

Note that the TOSA 310, ROSA 320, and equalizer 325 are shown with exemplary components, and other configurations may be used in some alternative embodiments (not shown). As one example, the TIA or other differential-signal producing circuitry may be considered part of the equalizer itself and is not necessarily directly connected to the device converting the optical signal.

In the embodiment of FIG. 4, the equalized output from combiner 350 is provided to an amplifier 355 and the amplified signal to splitter 360. One output of splitter 360 is provided to clock recovery module 365. The recovered clock and a second output of splitter 360 is provided to demux 370, which in this embodiment uses the recovered clock to demultiplex the signal that was multiplexed in the transmitter located upstream, for example in an OLT. A signal analyzer 375 receives the demuliplexed signals and processes all or a selected portion of them.

Note that the components of FIGS. 2 and 4 are shown in exemplary configurations, and there may be other components present in other embodiments, or in some cases fewer. Other variation is possible, for example, components shown directly connected in the figures may in other implementations be connected via one or more other devices. The components in either case are typically implemented in hardware or as software instructions stored on a computer-readable medium and executed by a hardware device. In some embodiments, components illustrated in FIGS. 2 and 4 may be integrated together or into other devices (not shown) that may also perform additional functions.

Although shown here in the context of a receiver in a network node such as an ONU, the solution may also be of value in the receiver of an OLT or similar node. Upstream transmissions tend to be bursty in nature and a receiver implementing the equalizer described herein may be better able to process received communications. In this case the equalizer may be adjustable, for example by adjusting the taps, for example in order to account for transmission path differences to the different ONUs in a PON. In an all-analog equalizer, of course, of course, the circuit does not have to be clocked. In such an implementation, the ONUs may or may not employ the solution to induce pre-distortion.

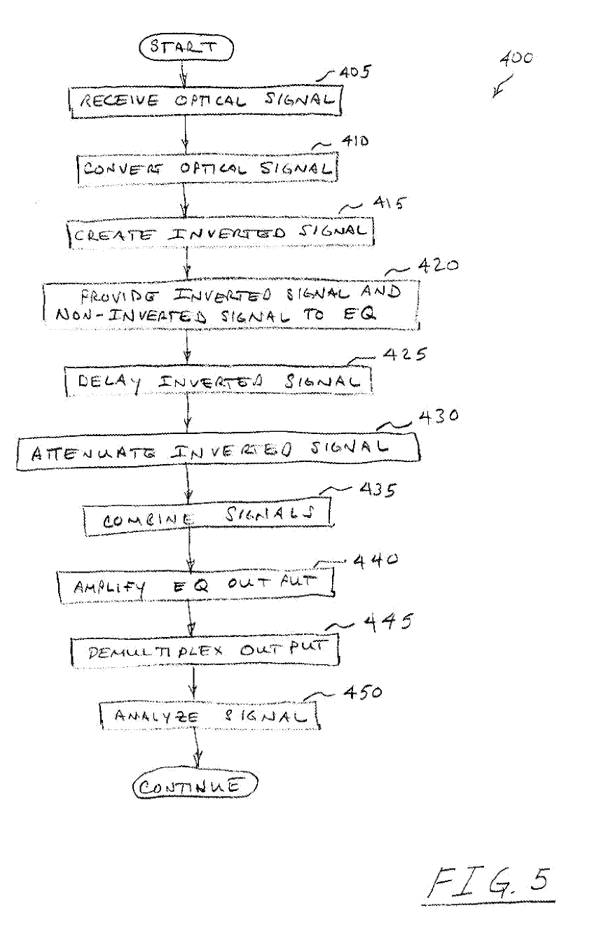

FIG. 5 is a flow diagram illustrating a method 400 of processing a communication signal in an optical network node according to an embodiment of the present invention. The network node may be for example an ONU such as the one depicted in FIG. 4. The method 400 may be of particular advantage in an ONU to mitigate the distortion that may result from the faster download speeds already being proposed in the industry. Note, however, that the method and apparatus described herein may also be used in a receiver elsewhere in the optical network, for example in an OLT, and may also be used in the transmit train in any of these devices so as to introduce pre-distortion to the signal.

In the embodiment of FIG. 5, at START it is presumed that the necessary components are available and operational according to at least this embodiment. The process then begins when an optical network node receives (step 405) an optical signal, for example on an access fiber such as one of those illustrated in FIG. 1 The network node then converts the optical signal into an electrical signal (step 410), for example using an APD such as the one shown in FIG. 4.

In the embodiment of FIG. 5, an inverted form of the signal is then created (step 415) such that both the inverted and non-inverted form of the signal may be provided (step 420) to an equalizer module. A TIA such as the one shown in FIG. 4 may be used to accomplish this. In this embodiment, the inverted signal provided to the equalizer in step 420 is delayed (step 425) and attenuated (step 430). The delayed signal is then combined (step 435) with the non-inverted signal to produce an equalized output.

In the embodiment of FIG. 5, the equalized output is then amplified (step 440) and provided to a demultiplexer that demultiplexes (step 445) the communication signal, for example from a 40 Gb/s multiplexed transmission to four component 10 Gb/s streams that are then analyzed (step 450) so that the relevant portions of the received signal may continue down the rest of the receive train (not shown), if any.

Note that the sequences of operation illustrated in FIGS. 3 and 5 represent exemplary embodiments; some variation is possible within the spirit of the invention. For example, additional operations may be added to those shown in FIGS. 3 and 5, and in some implementations one or more of the illustrated operations may be omitted. As another example, when the equalizer is used to induce pre-distortion in a transmitting node, the output of combiner 270 shown in FIG. 3 or combiner 350 shown in FIG. 5 may be provided to a transmit module (for example TOSA 310 shown in FIG. 5) for conversion to an optical signal for transmission. In addition, the operations of the method may be performed in any logically-consistent order unless a definite sequence is recited in a particular embodiment.

Although multiple embodiments of the present invention have been illustrated in the accompanying Drawings and described in the foregoing Detailed Description, it should be understood that the present invention is not limited to the disclosed embodiments, but is capable of numerous rearrangements, modifications and substitutions without departing from the invention as set forth and defined by the following claims.

1. A method of processing a communication signal in an optical network, comprising:
amplifying the communication signal to produce a differential output
delaying one of the differential outputs
attenuating one of the differential outputs
combining the delayed signal with the un-delayed signal.

2. The method of claim 1, wherein the same differential output is both delayed and attenuated.

3. The method of claim 2, wherein the differential output comprises a non-inverted signal and an inverted signal, and wherein the delayed and attenuated signal is the inverted signal.

4. The method of claim 1, where the delayed differential output is delayed by one bit.

5. The method of claim 1, wherein the communication signal is an RF electrical signal.

6. The method of claim 6, further comprising:
receiving an optical signal;
converting the received optical signal to an electrical signal; and
providing the electrical signal to the TIA.

7. The method of claim 5, further comprising providing the combined signal to a transmission module for conversion to an optical signal.

8. The method of claim 7, further comprising converting the combined signal into an optical signal.

9. Apparatus for processing a communication signal in an optical network, the apparatus comprising:
a differential signal producer configured to produce as an output a differential signal having at least an inverted output signal and a non-inverted output signal;
a delay circuit configured to delay one of the outputs of the differential signal producer;
an attenuator circuit configured to attenuate one of the outputs of the differential signal producer; and
a combiner configured to combine the delayed output and the un-delayed output.

10. The apparatus of claim 9, wherein the differential signal producer is a TIA.

11. The apparatus of claim 9, wherein the delay circuit and the attenuator are configured to respectively delay and attenuate the same output of the differential signal producer.

12. The apparatus of claim 11, wherein the delay circuit and the attenuator are configured to respectively delay and attenuate the inverted output.

13. The apparatus of claim 9, wherein the delay circuit is a delay buffer.

14. The apparatus of claim 9, wherein the electrical signal is an RF signal.

15. The apparatus of claim 9, wherein the apparatus is part of the receive train in an optical network node.

16. The apparatus of claim 15, further comprising a photodiode for receiving an optical signal and converting it into an electrical signal.

17. The apparatus of claim 9, wherein the wherein the apparatus is part of the transmit train in an optical network node.

18. The apparatus of claim 17, further comprising a transmit module for receiving the combined output and converting it into an optical signal for transmission.

19. An optical network node, comprising:
a photodiode for receiving an optical signal and converting it into an electrical signal;
a TIA configured to receive the electrical signal and produce as an output a differential signal having at least an inverted output signal and a non-inverted output signal;
a delay circuit configured to delay one of the outputs of the differential signal producer;
an attenuator circuit configured to attenuate one of the outputs of the differential signal producer; and
a combiner configured to combine the delayed output and the un-delayed output.

20. The optical network node of claim 19, wherein the network node is an ONU.

21. The optical network node of claim 19, wherein the network node is an OLT.
